(19) United States
(12) Patent Application Publication
(10) Pub. No.: US 2024/0037368 A1
(43) Pub. Date: Feb. 1, 2024

(54) MANAGING DISPLAY DEVICES USING MACHINE LEARNING

(71) Applicant: Hughes Network Systems, LLC, Germantown, MD (US)

(72) Inventors: Amit Arora, Germantown, MD (US); Sonia Thakur, Germantown, MD (US); Namrata Walanj, Germantown, MD (US)

(21) Appl. No.: 17/876,088

(22) Filed: Jul. 28, 2022

(51) Int. Cl. G06N 3/04; G06K 9/62; G06F 16/55

(52) U.S. Cl. CPC G06N 3/04; G06K 9/6256; G06F 16/55

(57) ABSTRACT

Methods, systems, and apparatus, including computer programs encoded on computer-storage media, for managing display devices using machine learning. In some implementations, a system receives image data representing an image provided for presentation by a display device. The system processes the image data using a machine learning model that has been trained to evaluate status of display devices based on input of image data corresponding to the display devices. The system selects a classification for a status of the display device based on the output that the machine learning model generated based on the image data. The system provides an output indicating the selected classification over the communication network in response to receiving the image data.

### BACKGROUND

The present specification relates to managing display devices using machine learning.

Display devices are used extensively in many public areas. For example, screens are used to display arrivals and departures at airports, to display menus at restaurants, to display advertisements in stores, to provide information and entertainment in company lobbies, and so on. Often, the devices used are televisions or computer monitors, although other devices are sometimes used, such as tablet computers or light-emitting diode (LED) billboards. In many cases, the content on the display devices is provided by an on-premises computer system or a remote server.

### SUMMARY

In some implementations, a system uses machine learning to perform automatic detection and remediation of errors and other problems at media signage displays. The system uses a machine learning model trained to classify the state of a display device based on image data indicating the content displayed at the display device. Display devices capture image data showing the content they display, for example, as a screenshot or screen capture performed by software of the device. The image data is then assessed using the machine learning model to detect whether the device is operating normally (e.g., showing content as desired) or is in an undesirable state (e.g., in a set-up mode, missing content, blank screen, etc.). When the model output indicates that a display device is not operating as desired, the system can select an action to address the problem. For example, the system can initiate a change to the configuration of the device, change a mode of operation of the device, reboot the device, etc. The system can use various rules or machine learning techniques to select the appropriate remedial action for a device. The system can also notify an administrator of problems identified and provide real-time status information and metrics about the state of display devices.

The system can be implemented using a server system that provides an application programming interface (API) for analyzing the state of display devices. The API can be accessed by servers that respectively manage display devices at different locations. For example, three different office buildings may each have a local signage server, and each signage server can manage multiple display devices. Each individual display device can periodically send a low-resolution image of content it displays (e.g., a thumbnail of a screenshot) to its corresponding signage server. The signage servers then send requests over a network using the API, with each request providing the digital image for a different display device. The response to each request from the API can include a classification determined using the machine learning model. The classification can indicate the predicted state of the display device (e.g., normal operation, setup screen shown, partial content shown, all content missing, etc.). The signage server can then use the classification for a display device to select and implement a corrective action to restore the display device to a normal state, if the display device was classified as not operating properly. In some implementations, the response provided through the API provide provides an indication or instruction of a corrective action to perform for a device.

The system provides user interface data for a user interface data that provides an administrator with current and historical information about display devices. For example, a signage server can provide user interface data for an administrator dashboard that provides real-time status information about a collection of display devices managed using the signage server, such as metrics indicating the number of display devices in different classifications (e.g., normal, inoperative, etc.), a number of screenshots analyzed, etc. The signage server can track information over time to show trends and patterns occurring among devices in certain locations or devices of different types.

The system can be configured to automatically re-train the machine learning models so that the models remain current and provide predictions that are as accurate as possible. If a user determines that the classification prediction of a model is incorrect, the user can provide input indicating the mistake and indicating the correct classification. The records of erroneous classification predictions, along with other labeled training data, can be used to update the training of the machine learning models to improve accuracy over time.

In some implementations, display devices can each have intelligent edge capabilities to perform machine learning inferences to evaluate the state of the display device. The intelligent edge capabilities can be provided by a media signage device itself (e.g., through an application or a software agent running on the device) or a local computing device (e.g., an embedded computer connected to the display device). For example, a media signage display or associated computing device can store the machine learning model trained to classify device state, and also store rules or models for selecting remediation actions. With the machine learning model stored and run locally, each display device can self-diagnose and self-correct, and network connectivity is no longer required for detection or remediation of problems.

In some implementations, the training of machine learning models is also distributed among a variety of remote devices to enable federated learning. For example, using the intelligent edge capabilities of a display device or associated local computer, individual devices can learn from the situations they encounter and update their local models. The updated models can then be provided to associated signage servers or to a central server supporting multiple signage servers, where the model changes can be combined or integrated into an updated model. The updated model can then be distributed back to the various local devices that then continue to monitor local conditions and further train the received model. With this technique, hundreds or thousands of display devices can participate in model training, and the improvements can be distributed so all devices benefit. In other implementations, even if model training does not occur for each display device, model training can be performed at various signage servers that each manage multiple display devices. The updated models or training updates made by the various signage servers can be collected by a central server that can integrate the various updates from training and provide an updated model.

Advantageous implementations can include one or more of the following features. For example, the system can perform ongoing monitoring of display devices, such as media signage displays, to automatically detect errors and problems. The system can also automatically select and carry out corrective actions to return the displays to normal operation. As a result, when a device reaches problematic state (e.g., content is missing in part of the screen, device screen is blank, device is stuck in a set-up mode, device operating system has crashed, etc.), the system can detect and correct the problem without requiring any user to detect or report the problem. This functionality greatly increases the uptime for a collection of display devices, especially as it can quickly detect and address problems with out-of-the-way screens that might otherwise remain unnoticed in an error state for long periods of time. The architecture and API provided by the system allows the system to support many media signage servers, each with their own set of managed display devices. In addition, the system can perform training in a repeated, ongoing manner using information reported by display devices, so that accuracy of classification predictions and the effectiveness of selected corrective actions increases over time.

In one general aspect, a method includes: receiving, by one or more computers, image data over a communication network, the image data representing an image provided for presentation by a display device; processing, by the one or more computers, the image data using a machine learning model that has been trained to evaluate status of display devices based on input of image data corresponding to the display devices, wherein the machine learning model has been trained based on training data examples that include image data from multiple display devices and include examples for different classifications in a predetermined set of classifications; selecting, by the one or more computers, a classification for a status of the display device based on the output that the machine learning model generated based on the image data, wherein the classification is selected from among the predetermined set of classifications; and providing, by the one or more computers, an output indicating the selected classification over the communication network in response to receiving the image data.

In some implementations, the machine learning model is a convolutional neural network.

In some implementations, the method includes training the machine learning model based on training data examples from multiple display devices, each of the training examples comprising a screen capture image and a label indicating a classification for the screen capture image.

In some implementations, the method includes providing an application programming interface (API) that enables remote devices to request classification of image data using the API; receiving the image data comprises receiving the image data using the API; and providing the output indicating the selected classification comprises providing the output using the API.

In some implementations, providing the output comprises providing the output to the display device, to a server associated with the display device, or to a client device of an administrator for the display device.

In some implementations, the method includes determining, based on the selected classification, that the output of the display device is not correct or that the display device is not in a desired operating state; based on determining that the output of the display device is not correct or that the display device is not in a desired operating state, selecting a corrective action to improve output of the display device; and sending, to the display device, an instruction for the display device to perform the selected corrective action.

In some implementations, the corrective action comprises at least one of changing content to display, changing a display setting, changing a network setting, changing an operating mode, restarting the display device, closing or re-opening an application, initiating a content refresh cycle, restoring one or more settings to a default or reference state, or clearing or refilling a cache of content.

In some implementations, selecting the corrective action comprises using stored rules that specify different corrective actions to perform for different classifications in the predetermined set of classifications.

In some implementations, the method includes tracking a status of the display device over time to verify whether normal operation of the display device occurs after instructing the corrective action to be performed.

In some implementations, the method includes, for each of multiple display devices: receiving a series of different screen capture images obtained at different times; determining a classification for each of the screen capture images using the machine learning model; and tracking status of the display device by storing records indicating the classifications determined for the screen capture images.

In some implementations, the machine learning model is configured to provide, in response to receiving input image data, a set of scores comprising a score for each of the classifications in the predetermined set of classifications.

In some implementations, the received image data is a down-sampled version of a screen capture image generated by the display device.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for managing display devices.

FIG. 2 is a diagram showing an example of techniques for training machine learning models.

FIGS. 3A and 3B are diagrams illustrating examples of machine learning model architectures.

FIGS. 4-6 are diagrams illustrating additional techniques for managing display devices.

Like reference numbers and designations in the various drawings indicate like elements.

### DETAILED DESCRIPTION

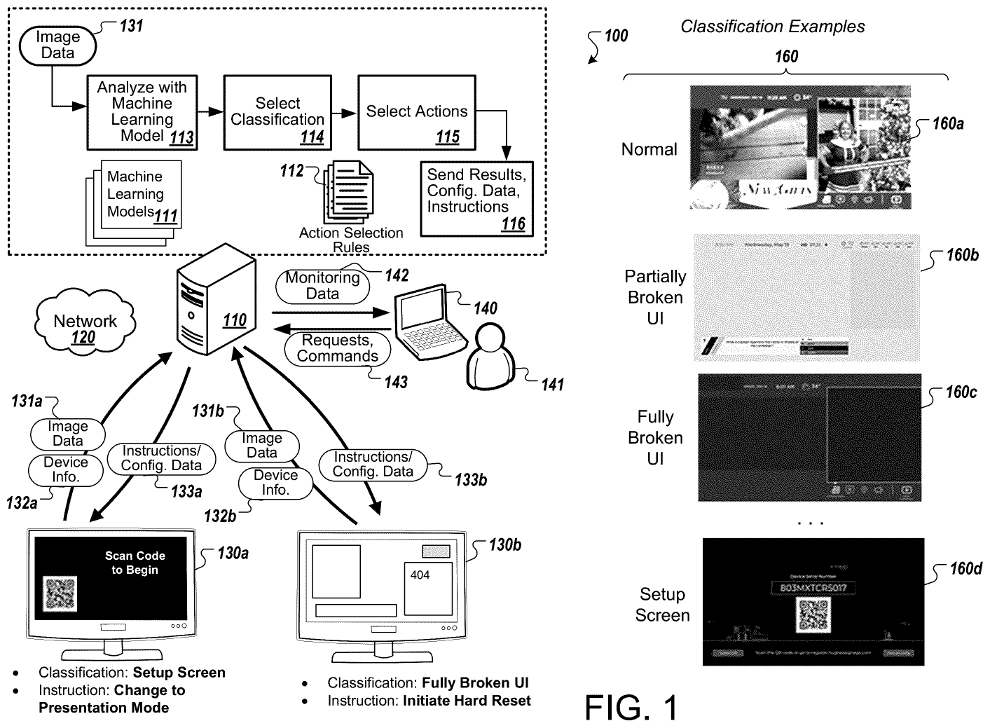

FIG. 1 is a diagram showing an example of a system 100 for managing display devices. The system 100 includes a computer system 110, such as a server, that communicates with remote display devices 130a, 130b over a communication network 120. The computer system 110 has one or more machine learning models 111 that it uses to evaluate and classify the state of the display devices 130a, 130b, and then provide instructions and configuration data as needed to bring the display devices 130a, 130b into a desired state of operation. The system 100 also includes a computing device 140 of an administrator 141. The computer system 110 communicates with the computing device 140 over the communication network 120 to provide status information about the display devices 130a, 130b and to respond to requests and commands from the administrator 141 sent by the computing device 140.

Many locations use media signage devices, for example, to display advertisements in stores, menus in restaurants, window displays, electronic billboard content and other advertisements, flight status information in airports, and so on. These devices are also used to show video in waiting rooms, display presentations in conference rooms, provide entertainment in breakout rooms, and provide content in a variety of other settings. In many cases, the devices are shared-use devices, often located in or viewable from common areas or public areas. These devices can take a variety of forms, including tablet computers, television screens, projectors, and electronic billboards.

Sometimes, a display device may be incorrectly configured or may malfunction, so that the display device no longer presents intended content properly. Display problems can occur due to any of various different causes, such as incorrect configuration settings, hardware errors, software errors, memory leaks, software incompatibility, power loss, network interruptions, file corruption, random errors, and so on. The many different types of malfunctions can result in different alterations or problems with the displayed content. As an example, some or all of the content may be missing. The user interface of a display device may be composed of multiple widgets, frames, or display areas, and one or more of these may stop working. As a result, a portion of the screen may become solid black or white, or may be frozen instead of being updated as intended. As another example, an application generating the content may malfunction or crash, leading to presentation of an error message, a blank screen, or an operating system user interface instead of the intended content. As another example, some or all of the content may become corrupted (e.g., garbled or distorted), or may be frozen on one view for an extended period. As another example, the display might be stuck in a setup mode, showing a default view or menu for the hardware or software.

In many cases, if a display device stopped working, the malfunction might go undetected by employees and might go unaddressed for long periods of time. If a malfunction was detected, it would traditionally need to be addressed by an employee making manual adjustments or contacting technical support to request repair.

Data such as screenshots from the media signage devices or other display devices are periodically pushed to the media signage server, or pulled from the display devices by the media signage server. These images are stored in a collection, such as in the cloud, a data center, or wherever the media signage server resides. This data is then provided for training machine learning models that are able to recognize various states (e.g., normal, broken, partially broken, setup screen) of the media signage displays. Access to the functionality of the trained models is then served using a representational state transfer (REST) API (e.g., hosted in the cloud, data center, or at the edge). The media signage server or the media signage device itself (e.g., in case the model is hosted at the edge) is able to use the machine learning model REST API to get an inference about the display device and then take a remedial action if needed.

The system 100 is designed to be able to monitor the operation of display devices at a large scale. The system 100 can automatically identify malfunctioning display devices and then take corrective action to restore any display devices that are not working correctly. The approach provides many advantages. For example, the system 100 improves the speed of detection and remediation. While a human user might notice a problem with a display by chance, this system 100 can provide regular, systematic monitoring with quick detection of any errors that occur. For example, the system 100 can be configured to obtain and evaluate screenshots for all monitored display devices periodically (e.g., every minute, every five minutes, every fifteen minutes, etc.), allowing the system 100 to detect and resolve problems much faster. In some implementations, detection speed can be increased further by implementing monitoring for each individual display device using intelligent edge techniques, where the inference processing is performed locally for each display device rather than from an API hosted using cloud computing resources.

In some implementations, a separate API layer front end is provided for the machine learning model REST API. This additional layer of provides data retrieval and processing functionality to first get a screenshot on which inference is needed from an object store and then convert a screenshot (e.g., a PNG file) into a stream of raw bytes that can then be provided to the trained model for inference. This separate API layer also tracks API usage and provides these metrics to a web portal that makes them available to the end user (network engineer, customer support, end customer).

The system 100 can also improve the scale of detection and remediation. Traditionally, it has been impractical and inefficient to monitor the operation of large numbers of display devices. Even at a single store, there can be so many display devices at different locations and oriented in different directions that a display device malfunction can easily go undetected and unaddressed for a significant period of time. The system 100 can be used to monitor many display devices, including display devices in many different networks. The architecture of the system 100 enables monitoring to scale easily, for example, in many cases simply by allocating more computing resources in cloud computing platforms. The system 100 can also be leveraged to provide customized monitoring or customized models for particular networks or sites, which can further improve the accuracy and effectiveness of the models. For example, different models can be trained for different companies, industries, or locations. The system 100 can starting with a general model based on a diverse set of screenshot examples, then train the general model differently for different locations based on more specific examples of what is presented at those locations. As a result, different groups of display devices can be monitored using models tailored more specifically for the type of content (e.g., layout, media type, color scheme, etc.) actually used for each group of display devices.

As another advantage, the trained machine learning models 111 can sometimes be better than a human at classifying the state of a display device. The machine learning models 111 can be trained using thousands of screenshots representing to a variety of different situations. This can enable the machine learning models 111 to discover the nuanced differences in content between normally operating display devices and malfunctioning ones, as well as to better detect and distinguish between the different types of malfunctions and their causes. As a result, the machine learning models 111 can learn to identify conditions and patterns that that are difficult to for people to detect. As a few examples, the machine learning models 111 can include one of a neural network, a support vector machine, a classifier, a regression model, a clustering model, a decision tree, a random forest model, a genetic algorithm, a Bayesian model, or a Gaussian mixture model.

Another advantage of the system 100 is the ability provide fine-grained classifications of the types of problems that may occur. This increases the value of the tracking data that the system 100 provides, as well as increases the effectiveness of the corrective actions selected, because the corrective actions can be better aligned to the particular situation that is present. In many cases, a binary classification whether a display is operating properly or not can be helpful. But a more specific indication of the status of a device and nature of a malfunction, if any, can be more valuable. Various implementations of the system 100 use machine learning models 111 that are capable of much more specific determination of the state of a display device. As discussed below, this can be implemented by using machine learning inference to select from among multiple different classes, which respectively represent different levels of operation, operating states, different types of malfunctions, different situations or contexts, and/or different visual properties or combinations of visual properties present. As an example, beyond simply classifying whether display devices are in normal operation or are malfunctioning, the system 100 enables more targeted classifications, such detecting when a device is showing a “setup screen.” In some cases, the more detailed classifications can help with troubleshooting an installation process, with the system 110 able to automatically detect the current stage in an installation workflow for a device and guide a human user accordingly with the instructions or settings needed to complete the installation.

The present technology can assess media signage displays to detect if a display screen is functioning normally or at least is providing the content that is expected. In some cases, the analysis is done based primarily on or completely on what is displayed on the screen or what is generated and provided to be displayed on the screen. A display can be considered to be not working properly if parts of the screen or the entire screen are not being displayed correctly (e.g., blanked out, solid white or black instead of desired content, etc.) or if the display is stuck at some error screen such as the setup screen for a device installation or software installation workflow.

A multi-class classification model is trained using many example screen captures, such as tens of thousands of screenshots to classify different types of screen display conditions, e.g., normal, partially broken, broken, or setup screen. The trained machine learning model can then be used for inference (e.g., prediction) on a screenshot from a display screen to identify the category (e.g., normal, broken, partially broken etc.) in which the screenshot falls. A server known as a media signage server that manages or supports various display devices can invoke this API on screenshots of media signage devices operational in the field and determine which devices are not normal and then take steps to remediate those devices, all without any human intervention. The application stack for the technology has three major parts: (1) data collection and model training, (2) model inference, and (3) remediation.

For data collection and model training, data collection is done by retrieving screenshots from the media signage server and then labelling them into the different categories (e.g., normal, broken, etc.) and then this labelled data is used to train a deep learning model. In some cases, a convolutional neural network is used, but other model architectures can be used. Multiple model types can be tested, and the one with the best model performance metrics (e.g., f1-score, mean class error etc.) is selected.

Model training can also happen in a federated fashion using federated learning where a portion of the model training computation (e.g., gradient descent) runs on each media signage device and the results are combined in a federated learning server running in the cloud or a data center. Federated learning may use either a separate intelligent edge device alongside the media signage server or as part of the media signage server to provide the necessary compute capabilities needed for training the model.

Regardless of where the model training happens (e.g., at a central location or federated) several versions of the model are trained. A global version that is trained using screenshots from all networks and is therefore trained to provide inference for any screenshot from any network. A network-specific version (e.g., one for each network) can be trained only using screenshots from that network, or can weight screenshots for that network more highly than other examples used in training. This network-specific version captures any patterns that might be specific to a network (e.g., visual properties or failure modes that are typical for display devices in that network) and may not seen in other networks. The model performance metrics guide which model(s) is/are used or a combination of models is used for providing the final inference.

For model inference and serving the machine learning model, once trained, access to the machine learning model is provided through a REST API which is given an input screenshot from a media signage display. The API can provide an inference (e.g., classification prediction) as to which category the screenshot belongs to. The trained model hosted as an API can exist in one of three locations: (1) a public cloud computing system, (2) a service provider or customer data center at or adjacent to the media signage server, and (3) at the edge as part of the media signage display or an additional intelligent edge device.

Each of the three model deployment options have their pros and cons and this invention discusses all of them. Cloud deployment of the model provides easy and cost-effective load scaling. The public cloud may exist in a different public cloud or network from the media signage server, so additional network access and security configuration can be done to enable appropriate communication. Data center deployment provides enhanced security and control by the customer, and some customers might require this as part of their security or other business considerations. Deployment and load scaling may require additional compute resources which may not be as easy to procure as in the cloud computing scenario. Edge deployment of the machine learning model provides the fastest response time as it is co-located to the media signage device. Inferences are also available when operating in offline mode, e.g., when Internet (data center, cloud) is not available. The intelligent edge platform can be used for hosting additional data analytics and machine learning apps as well. Of the three options, development and deployment is more complex in the distributed, edge-deployed scenario.

For remediation, once the media signage server (or the intelligent edge device) can get an inference that the media signage screen is not in normal state it can take some corrective actions. These actions can include (but are not limited to) resetting (soft reset, power off/on) the media signage device, switch storage device to Internal storage, invoking an media signage server API to reconfigure the media signage device or to simply create a ticket in a problem tracking system such as Salesforce or ServiceNow so that the device experiencing the problem is now added to a regular problem tracking workflow and would be looked at by customer support.

Still referring to FIG. 1, the computer system 110 monitors and manages various display devices 130a, 130b. The computer system 110 can be implemented as a remote server system, e.g., in a cloud computing platform, a data center, or a centralized server remotely located from the display devices 130a, 130b. The computer system 110 can provide a management service that can be used to monitor and manage display devices at many different locations, including to separately monitoring and manage various display devices at each location (e.g., individual stores, office buildings, etc.). The display devices 130a, 130b can be media signage devices, and may be located in public areas or areas of shared accessibility, but the display devices 130a, 130b can be any of various types of devices, including tablet computers, television screens, projectors, signs, and electronic billboards.

The display devices 130a, 130b are each configured to present content. The devices 130a, 130b may each run software that specifies the content to be displayed. Different devices 130a, 130b may be configured to present different types of content, for example, with devices in different locations or devices of different companies being configured to use different layouts, color schemes, media types, media assets, and so on. The content displayed can be interactive, such as a user interface with interactive touchscreen buttons or other onscreen controls. In other cases, the content can be a predetermined layout, with elements such as advertisements, images, video, text, and so on being presented without user interactivity. The devices 130a, 130b can be configured to adjust the content presented, such as to change which images, videos, or text is presented according to a schedule, as instructed by a server, or in another manner.

The devices 130a, 130b each periodically capture an image of the content that they display and send it to the computer system 110. For example, at a predetermined interval (such as every 5 minutes, every minute, etc.), each device 130a, 130b obtains a screenshot image or screen capture of the content provided for display. The screenshot can be taken from output of rendering software or from a software or hardware buffer (e.g., such as a frame buffer or display buffer of an application, operating system, display adapter driver, a graphics processing unit (GPU), a system on a chip (SoC), etc.). The devices 130a, 130b can down-sample or resize the image to a smaller size, e.g., from an output resolution of 3840×2160 pixels to a lower-resolution “thumbnail” type image with a size of 384×216. This can greatly reduce the amount of information that needs to be processed and transferred over the network while still retaining information about the most prominent visual features of the displayed content. The devices 130a, 130b may then send the down-sampled image data to the computer system 110 as image data 131a, 131 b.

The devices 130a, 130b may also capture additional state data indicating the operation of the devices 130a, 130b and send it as device information 132a, 132b. For example, the device information 132a, 132b can indicate various items such as time powered on, which applications are running, current device settings or software settings, indications of error codes if any, and so on.

The computer system 110 receives the image data 131a, 131 b from each monitored display device 130a, 130b and uses a machine learning model 111 to classify the state of each device 130a, 130b based on its image data 131a, 131 b.

Once image data 131 is received, the computer system 110 analyzes the image data 113 with a machine learning model 111 (step 113). In some implementations, the computer system 110 stores multiple machine learning models that have been trained or optimized for different situations, such as for: different companies (e.g., which may have different logos, color schemes, layouts for content, etc.); different locations (e.g., different countries, different states, different cities, different buildings, etc.); different uses or applications (e.g., advertising billboards, travel arrival and departure signs, restaurant menus, sports scoreboards, etc.); different device types (e.g., tablet computers, televisions, devices of different manufacturers, different models of devices, etc.); different software or content templates used; and so on. The computer system 110 can select an appropriate model to use, from among the set of stored models, based on information from the display device 130a, 130b. For example, the devices 130a, 130b can provide a device identifier, a company or customer identifier, a location name, or other identifier that can indicate the setting or context of the device 130a, 130b that provided the image data 131a, 131 b. From this, the computer system 110 can select the model that best fits the context of the device (e.g., a machine learning model for the company associated with the device 130a, 130b, or a machine learning model that fits the use or application for the device 130a, 130b). The computer system 110 can store data that maps different identifiers to appropriate machine learning models, such as a list of device identifiers that each correspond to a particular company and thus that company's trained machine learning model. In other implementations, a general machine learning model can be selected to be used, especially if no specialized model fits the situation of the device 130a, 130b.

The machine learning model 111 can be a trained convolutional neural network. The input to the neural network can be pixel intensity values for a received image. For example, for a 384 pixel by 216 pixel thumbnail image, three values can be provided for each pixel, to indicate the values for the red, green, and blue color channels of a color image. In some implementations, input to the model 111 can additional include feature values determined from other information about the display device, such as a feature value indicating a location of the device, a type of the device, a mode that the device is intended to be operating in, etc. Input feature values can also include values determined from the received device information, to indicate characteristics of the current status of the device (e.g., the device type or device model, the presence or absence of error codes, indication of which software is running, indications of which versions of software or firmware is used, indications of hardware settings or software settings, etc.).

In response to receiving the input data, the model 111 provides output indicating the relative likelihood that various classifications from a predetermined set of classifications are appropriate given the input data. The example of FIG. 1 shows four possible classifications each with a corresponding example image: normal operation (image 160a), a partially broken interface (image 160b), a fully broken interface (image 160c), and a setup screen (image 160d). Examples of each of these different classifications have been used to train the model 111, so the model 111 can distinguish among them and indicate the relative likelihood that the input image data 131 represents the different classifications. The output from the model 111 can be a set of scores, each score indicating a likelihood that a different classification is the correct one. In the example, the output can be an output vector with four values, one for each of the four different possible classifications. Optionally, the values can form a probability distribution over the set of classifications, where the scores sum to 1.

Based on the output from the model 111, the computer system 110 selects a classification for the input image 131 (step 114). With an output vector indicating the relative likelihoods of the four possible classifications, the computer system 110 can select the classification indicated to have the highest likelihood. For example, the computer system 110 can select the classification that received the highest score. The computer system 110 stores the classifications determined in a database so that the state of the display devices 130a, 130b can be tracked and the data can be retrieved and viewed later by an administrator.

Once the classification for the input image is determined, the computer system 110 can select actions to perform (step 115). The computer system 110 can store action selection rules 112 that specify actions to perform for different classifications of display device state. The action selection rules 112 can be specified using any of various techniques, such as a table, a look-up table, a software module, a machine learning model, etc. As an example, the action selection rules 112 can specify that when the classification of “normal operation” is selected for a display device 130a-130b, no action needs to be taken. The action selection rules 112 can specify that for the “partially broken interface” classification, the action to be taken is to refresh a cache of content at the device or to change a network setting. The action selection rules 112 can specify that for the “fully broken interface” classification, the action to be taken is to restart the software for the interface or to perform a restart (e.g., operating system restart, hard reboot, etc.) of the display device. The action selection rules 112 can specify that for the “setup screen” classification, the action to be taken is to notify an administrator or to initiate a change in mode of the display device 130a-130b.

The classifications and corresponding actions to perform stated above are provided simply as examples, and other classifications and other responsive actions can be set. In some cases, the action selection rules 112 specify conditions for selecting different actions for different situations. For example, for the “partially broken interface” classification, the rules 112 may specify to take one action for a certain type of display device, but to take a different action for a different type of display device. Similarly, the rules 112 may specify different actions to take based on different device status indicated in the device information 132a, 132b.

The computer system 110 can also continue to monitor the state of display devices to verify that they return to normal operation after corrective actions are selected and instructed to be performed. For example, the rules 112 may specify a first action to be performed (e.g., refresh a cache of stored content) when the “partially broken interface” classification is first identified. The computer system 110 can continue to monitor the state of the display device afterward over multiple analysis cycles that each analyze a new screenshot provided by the device. If the “partially broken interface” classification persists rather than changing to the “normal operation” classification (e.g., after the corrective action is performed, or after a predetermined amount of time elapses or a predetermined number of further analysis cycles are performed), then the computer system 110 select a different corrective action to instruct. For example, the rules 112 can specify that if a first action (e.g., refresh a cache of content) is not successful, then to perform a soft restart of the device, and if that is not successful then to perform a hard reset of the device. The rules 112 may specify that if the problem remains after those actions, that an alert be provided to the administrator 141. The rules 112 can specify many different corrective actions which may be selected based on device characteristics, previous corrective actions instructed, and the recent series of classifications, as well as other factors.

The computer system 110 can then then sends classification results and other data in response to the received image data 131a, 131b (step 116). If the classification selected is “normal operation,” then no action is required. The computer system 110 may simply record the status classification in its database, and optionally the computer system 110 may respond with the classification result or an acknowledgment that the device is operating properly. For other classifications that are not normal, in addition to logging the classification result, the computer system 110 can send data indicating the classification results and the corrective actions that the computer system 110 selected. For example, the computer system 110 can instruct devices to perform the corrective actions that the computer system 110 selected for the devices based on the respective classifications determined using the machine learning model 111.

In the example of FIG. 1, the computer system 110 determines that the display device 130a has a classification of “setup screen.” As a result, the computer system 110 determines that the action to perform is to “change to presentation mode.” As a result, the computer system 110 sends an instruction 133b to the device 130a over the network 120 instructing the device 130a to change to presentation mode. The software of the device 130a can be configured to act on this instruction, and consequently change the operating mode to return to the desired operating state.

Also in the example of FIG. 1, the computer system 110 determines that the display device 130b has a classification of “fully broken interface.” As a result, the computer system 110 determines that the action to perform is to “initiate a hard reset,” and thus power cycle the device. As a result, the computer system 110 sends an instruction 133b to the device 130b over the network 120 instructing the device 130b to perform the reset. The software of the device 130b can be configured to act on this instruction, and thus perform a hard reset of the device, which has the potential to bring the device 130b back into a normal operating state.

When needed, the computer system 110 can send configuration data, updated settings values, software updates, firmware updates, or other additional data to devices 130a, 130b as part of instructing corrective actions.

The computer system 110 makes the information about current and former status of display devices 130a, 130b available to the administrator 141 over the network 120. For example, the computer system 110 can provide a web-based portal as a web page or web application, or may allow status information to be queried through an application programming interface (API). The computer system 110 can also generate and send periodic reports about a set of display devices 130a, 130b that the administrator 141 is associated with (e.g., devices for the company or location that the administrator 141 manages). The computer system 110 can also be configured to send alerts and notifications when certain conditions occur, such as when classifications representing anomalous operating conditions are determined, or when those classifications persist for at least a predetermined amount of time or number of cycles, or when those classifications are not corrected by the automatic corrective actions that the computer system 110 selects and instructs to be performed.

The example of FIG. 1 shows that the computing system 110 can provide monitoring data 142 to administrator's device 140 for display in a web portal. The information in the portal can be provided in response to requests or commands 143 initiated by the administrator 141. The monitoring data 142 can indicate current status of display devices, based on the classifications determined for the devices. The monitoring data 142 can include real-time indications of device status, based on the most recent screenshot image data and the classifications determined based on them.

The monitoring data 142 provided and presented in the interface can include information about individual display devices, an entire set of managed display devices, or for different subsets or groups of display devices, such as groups defined by device type, location, use or application, or other categories. In addition to current status, the monitoring data 142 can include information about previous status, such as status of individual devices or groups of devices by hour, day, week, month, or other time period. The computing system 110 can provide a dashboard with summary information and statistics, as well as alerts showing specific display devices or locations that need corrective action to be taken by the administrator 141. The interface of the web portal can include interactive controls that provide functions to search for display devices with certain status classifications, to search for status information about specific display devices, locations, device types, or other properties. The interactive controls can enable user input to filter or rank information about display devices.

In some implementations, the web portal presented at the administrator's device 140 provides functionality for an administrator to view corrective actions performed as well as initiate new corrective actions. For example, the portal can include interactive elements to initiate device management operations for remote display devices 130a, 130b (e.g., to restart a display device, to change network settings, to refresh cached content, to change which software or content is used by a display device, etc.). Once the administrator 141 enters a desired command, the information is transmitted to the computer system 110, which then sends the appropriate instructions and/or configuration data to the appropriate display devices 130a, 130b.

The features shown and described for the computer system 110 can be divided among multiple different computer systems. For example, training of machine learning models, machine learning classification of screenshot image data, and the selection of corrective actions may be performed by a single computer system, such as a server implemented using a cloud computing platform. As another example, these functions and others can be divided among multiple servers, which can be implemented in cloud computing resources, on-premises servers, or a combination of both. For example, a first server can be used to store training data, to train machine learning models, and to perform machine learning classification of incoming screenshot data. The first server can provide an API gateway to receive incoming screenshots from display devices 130a, 130b, as well as to provide the monitoring data 142 (e.g., statistics, status information, alerts, etc.) for the web portal to administrators. A second server could act as a media signage server as an intermediary between display devices 130a, 130b and the first server. The media signage server can be implemented as a cloud-based environment, a data center, an on-premises server, etc. Display devices 130a, 130b can provide their screenshot images and other telemetry to the media signage server, and the media signage server can forward the screenshots to the first server in requests, made through the API gateway, for classification to be performed. The first server then sends the classification results to the media signage server according to the API in response to the requests. The media signage server stores the rules 112 and uses them to select and instruct corrective actions, as needed, to the display devices 130a, 130b that it manages. In this way, the classification function may be performed by a first server and can be accessed through an API, while the management and control of the display devices 130a, 130b, including instruction of specific corrective actions, can be done be a second server.

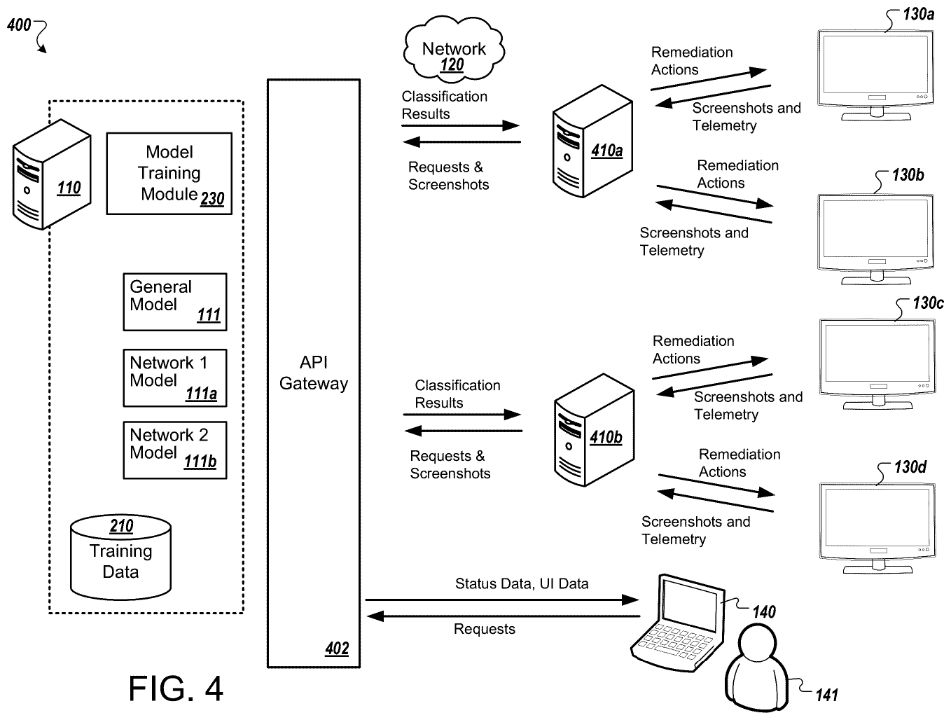

There can be multiple media signage servers that each manage different sets of display devices, and that each make use of the API to obtain the classification results for the display devices that they manage. For example, each company may run a separate media signage server to serve content to its display devices. The media signage servers can use the API and its classifications to better adjust the configurations and content used for the respective sets of display devices they manage. Further examples of these arrangements that can be used, as well as options for distributing machine learning model training, are illustrated in FIGS. 4-6.

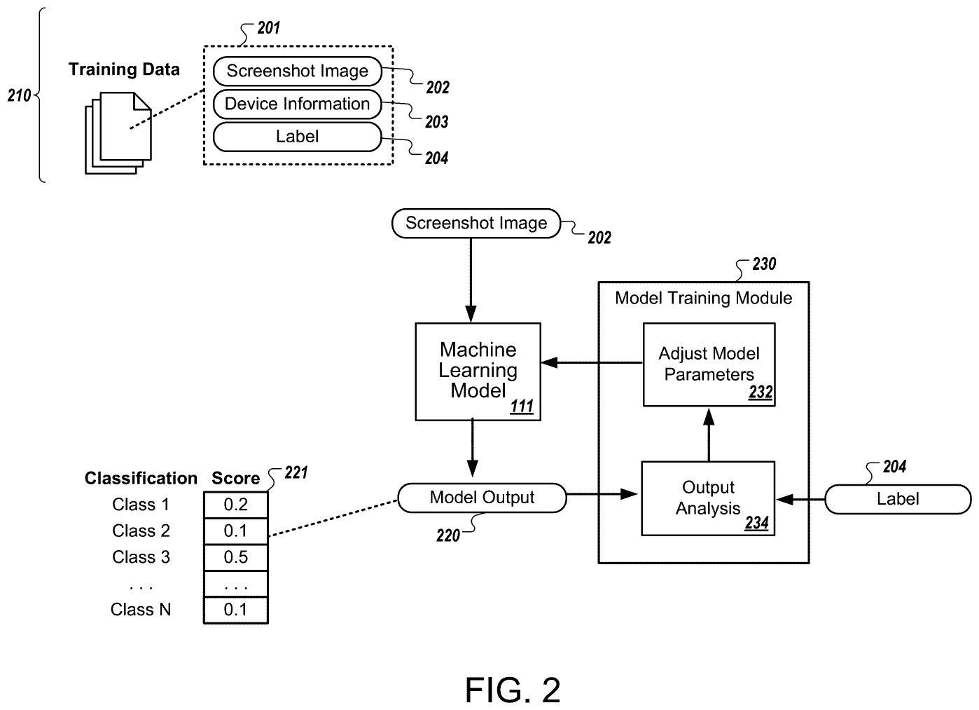

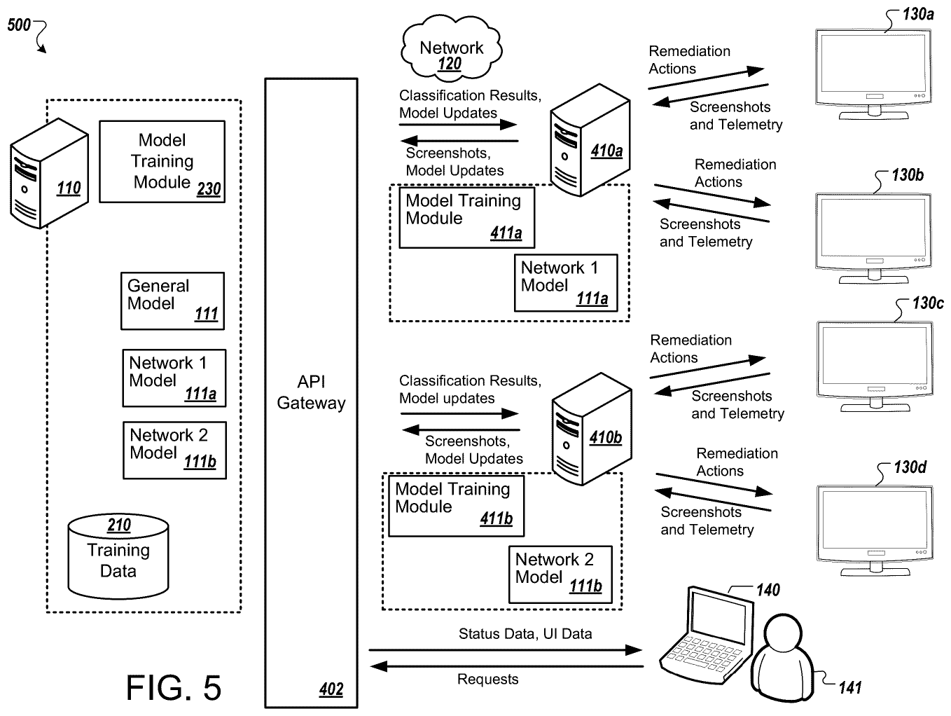

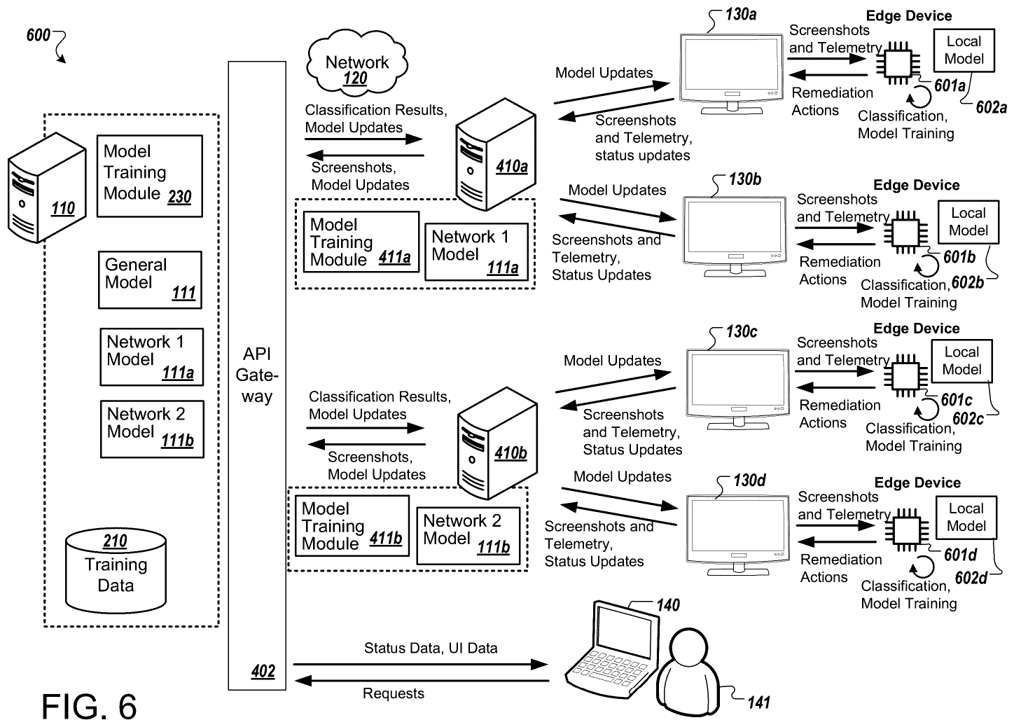

FIG. 2 shows an example of processes used to train a machine learning model 111. The training process can be performed by the computer system 110, for example, a centralized server, a cloud computing-based server, or computing functions distributed across multiple servers. As discussed further with respect to FIGS. 5 and 6, model training can also be done at other devices, such as at a media signage server that communicates with the computing system 110, or even at display devices or edge devices themselves.

Once the data various examples of screenshots are collected, a model training pipeline runs periodically to train machine learning models on this data. One type of model architecture that can be used is that of a convolutional neural network (CNN). The architecture of this network has several layers to create a deep neural network that has enough free parameters to learn patent patterns in the data and recognize them when seeing new data (e.g., new screenshots provided as input to the trained model). The model can be a multi-class classification model.

To train the machine learning model 111, the computer system 110 uses a set of training data 210. The training data 210 includes many examples of screenshot images 202 captured by different display devices. For example, various examples 201 in the training data 210 can respectively include images from different types of display devices, from display devices in different settings or uses, from display devices at different locations, from display devices used by different organizations, and so on. As a result, the training data 210 includes examples of many different states of operation of display devices in many different situations and configurations, including many different examples showing the visual characteristics of normal operation, as well as examples of many different types of malfunctions, improper configurations, setup processes, and other device states that are different from normal display operation.

When display devices 130a-130b provide their screenshot images 202, they can also provide other information 203 indicating their status at the time the screenshot was captured. The additional device information 203 can include context information, status information, telemetry, and so on. For example, device information 203 can include an identifier for a particular device to uniquely identify that device, and identifier for the organization or network associated with the display device, a current or recent amount of CPU processing utilization, an amount of available memory, an indication whether in error state is detected, a software version or firmware version executing on the display device, an indication of hardware capabilities of the device, a geographical location of the device, a time of day, and so on. The type of device information 203 that is captured and used can vary according to the implementation.

Each example 201 in the training data 210 can be assigned a label 204. The label can indicate a classification, selected from among various predetermined classes or categories, that is believed to best describe the state of the display device as shown by the image 202. The label 204 can represent the actual “ground truth” operating state of a display device at the time the screenshot was captured, as closely as can be determined by an observer or by analysis of the a system. The label 204 can be assigned by a human that reviews and rates the screenshot image 202 and selects the label 204 that appears to best represent the state represented by the image 202.

For example, the machine learning model 111 may be designed to distinguish and predict classifications from among a set of N predetermined classes. Each of the N classes may represent a different operating state or condition of a display device. For example, class 1 may represent normal operation, class 2 may represent a partially broken output (e.g., some useful or correct information but also some missing or corrupted regions), class 3 may represent a fully broken output (e.g., the primary content or even the entire display is missing, incorrect, or corrupted), class 4 may represent an initial setup screen, and so on.

As noted above, the label for a given training example 201 can indicate a classification selected by a human that reviews the screenshot image 202. However, in some cases, the label 204 may be determined automatically by a computer system such as the computer system 110 based on other analysis, including based on features of the device information 203. For example, if log data in the device information 203 indicates a failure to access a linked media item over a network, that entry may indicate that a particular class should be assigned as the label 204. As another example, an error or crash in a software program, indicated by the device information 203 to be currently affecting the device, may similarly indicate a label 204 to be assigned.

Once the screenshot images are labelled, they are stored, or in some cases uploaded in an object store in cloud computing storage, from where the model training pipeline can access them. Typically, several hundred or even thousands of images of each classification or category are used to train a high-performance, high-accuracy model.

The computer system 110 includes a model training module 230 that is configured to perform many training updates based on different training examples 201. Through many iterations of training, the machine learning model 111 gradually and incrementally learns to make more and more accurate predictions about the classification or state of a display device based on the screenshot image 202 for the display device. The training process illustrated in FIG. 2 can be used in the initial generation of the machine learning model 111. In addition, or as an alternative, the training process shown in FIG. 2 can be used to update or enhance an existing machine learning model 111, even after the machine learning model 111 has been deployed and is in use. Through ongoing collection of training data 210 and continuing training iterations based on those new examples, the computer system 110 can improve its accuracy over time and can learn to respond to new situations and screenshot characteristics that may appear over time.

Each training innovation can be based on one of the training examples 201. The input to the machine learning model 111 can be the screenshot image 202. The screenshot image 202 can be a downsized (e.g., downscaled, down-sampled, or subsampled) version of the image that the display device is set to display. For example, if the display device is configured to display an image with a size of 3840×2160 pixels, the display device may provide a lower-resolution image or “thumbnail” type image with a size of 384×216 pixels to be used in assessing the state of the display device.

Image information can be provided to the machine learning model 111 as a series of pixel intensity values. For example, if the machine learning model is configured to evaluate images that are 300×200 pixels in size, the input to the machine model 111 can be, or can include, a value for each of these pixels for each of the color channels, e.g., red, green, and blue. For example, for a 300×200 image of the RGB image type, the input vector would be 18000 values, 6000 values each for each of red, green, and blue pixel intensities, thus providing the image content for the thumbnail screenshot data as input to the machine learning model 111.

In some implementations, the machine learning model 111 makes classification decisions based only on the screenshot image 202. And other implementations, additional information can be provided as input to the machine learning model 111 to increase accuracy. For example, one or more elements of the device information 203 can be provided as input, so that the machine learning model 111 receiving information indicating the geographic location, organization, software program, visual template, or other information about the context in use of the display device, which in some cases may help the machine learning model 111 better predict the classification represented by the screenshot image 202.

After receiving the input vector having the screenshot image 202 and potentially other future values, and the machine learning model 111 generates an output 220. This output 220 can be an output vector 221, having values indicating relative likelihood that the various predetermined classes are applicable given the screenshot image 202 providers input. The machine learning model 111 can be structured so that the upper factor includes a score for each of the predetermined classes. For example, the machine learning model 111 can be configured to generate an output vector 221 that provides a probability distribution over the set of predetermined classes. For example, the model 111 can be trained so that the scores in output vector 221 sum to 1 to represent a total of 100% probability across the set of classes. In the example, scores are assigned to the classes and the highest score indicates that the corresponding class (in this case, class 3) is predicted to be most likely to represent the state of the display device. This can be achieved, for example, using a neural network as the machine learning model 111 and using a softmax layer at the final processing step of the neural network, so that the output is a probability distribution over the predetermined set of classes.

The model training module 230 then uses the model output 220 for the current training example and the label 204 for the current training example to determine how to adjust the parameters of the model 111. For example, an output analysis module 234 can compare the highest-scoring classification indicated by the model output 220 with the classification indicated by the label 204. If the classification predicted by the model does not match the label, the output analysis module 234 can identify that, for the features of the input image 202, the model 111 should be adjusted increase the likelihood of the classification indicated by the label 204 and/or decrease the likelihood of other classifications that do not match the label 204. The output analysis module 234 may calculate an error measure or a value of an objective function to quantify the error represented by the difference between the model output 220 and the label 204. The results of the analysis are provided to a model parameter adjustment module 232 that alters the values of parameters in the machine learning model 111. For example, in a neural network, the adjustment module 232 can adjust the values of weights and biases for nodes (e.g., neurons) in the neural network.

The analysis module 234 and the adjustment module 232 can operate together to train the model 111 using any appropriate algorithm such as backpropagation of error or stochastic gradient descent. Through many different training iterations, based on various different examples 201 in the training data 210, the model 111 learns to accurately predict the classifications of a display device or its screen content, based on input of the screenshot for the device. The model 111 can be trained on several hundred or several thousand screenshot images, and the model 111 is evaluated for error and accuracy over a validation set. The model training continues until either a timeout occurs (e.g., typically several hours) or a predetermined error or accuracy threshold is reached.

As discussed further below, the model training process can be used to create many different machine learning models, which can be tailored or customized for different companies, locations, display device types, networks, and so on. For example, after a general model is generated, the model may be further trained with training data examples for a particular company to create a customized model that is even more accurate for the types of devices and displayed content used by that company. By combining general training data or a general model with a training process that adds or more highly weights training data for a specific company or network, the system can generate a model that retains the broad coverage and broad capability of the general model with increased accuracy for the visual content characteristics and situations that occur most frequently for the company or network.

In general, multiple models 111 are created. One can be a global model that is trained on all images from all customers, and others can be customer-specific models that are created only using data (e.g., screenshots) from media signage devices from those customers. Each model is evaluated for model performance metrics (e.g., F1 score, mean class error, etc.) and only those models that have model metrics above a configured threshold are deployed for inference.

Another purpose of creating a global model and customer-specific models is that in some implementations, inferences can be obtained from both types of models, and a display would be categorized as anything other than normal if and only if both the global and customer specific models agree. This can be done because ensemble models may perform better in some scenarios.

Model training and re-training can be performed repeatedly at a pre-configured cadence (e.g., once a week, once a month) and if new data is available in the object store then it automatically gets used as part of the training. The data pipeline to obtain new data remains the same as described above. In some cases, a new version of the model is deployed only if it is determined by the system to meet or exceed the configured model performance metrics threshold. An email alert is sent out each time a new version of the model is trained and deployed. This is done as an automated activity to guard against model fatigue. Model retraining and redeployment is significant feature for the system to remain robust and accurate as display content, layout, and general usage of display devices changes over time and as customer needs change.

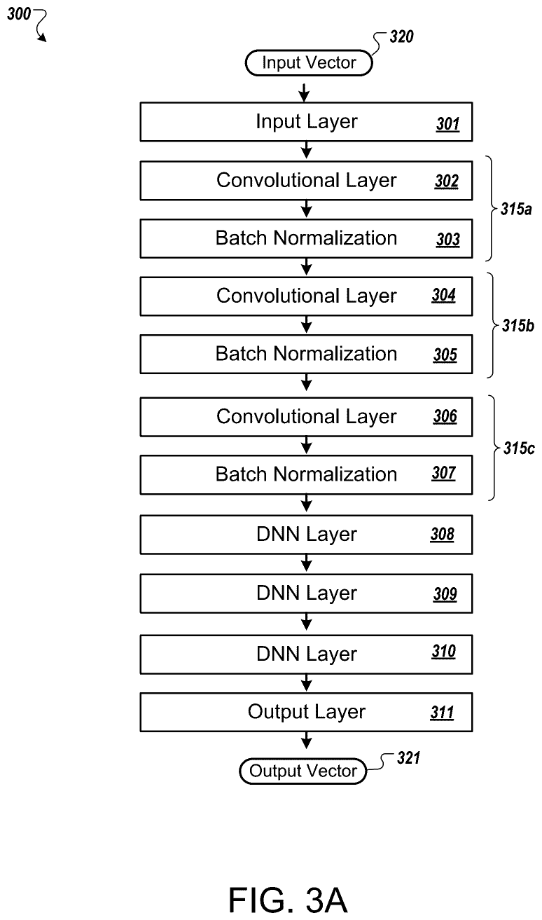

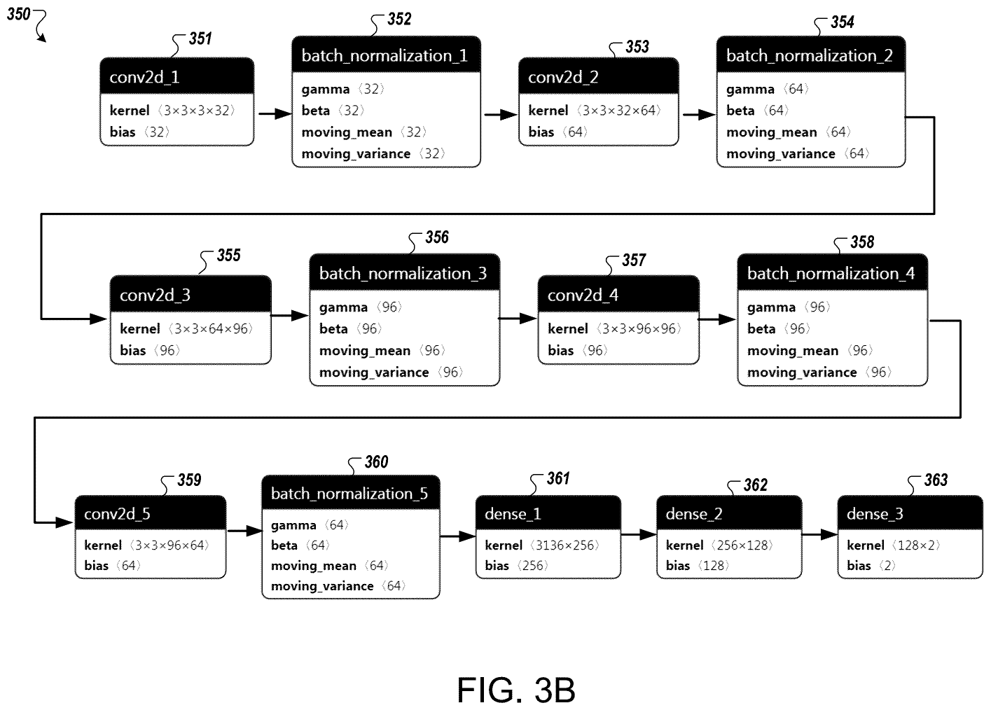

FIG. 3A shows an example of a neural network 300 that can be used as a machine learning model 111. The neural network 300 is configured to receive an input vector 320 that includes future values indicating the contents of a screenshot image. For example, the input factor 320 can include a low-resolution or down-sampled image representing what is shown on the screen of a display device, or at least what is provided to be displayed by the device. The screenshot image can be based on content of a buffer of the display device, such as a frame buffer, storage of data output for display, or other buffer.

The neural network 300 is configured to provide an output vector 321 that indicates a prediction about a classification of the state of the display device. For example, the other vector 321 can indicate probability values for each of multiple different classifications. The values in the upper vector 321 can be scores for the respective classifications, indicating which classification the model 300 predicts to be most likely for the input vector 320.

The neural network 300 is illustrated as a feedforward convolutional deep neural network. Then neural network 300 includes layers 301-311. These layers include an input layer 301, a convolutional layer 302, a batch normalization layer 303, convolutional layer 304, a batch normalization layer 305, the convolution layer 306, a batch normalization layer 307, three DNN layers 308-310, And an output layer 311. As shown in FIG. 3A, the neural network 300 includes multiple pairs of layers that each include a convolutional layer and batch normalization layer. For example, there are three layer pairs 315a-315c illustrated, although more or fewer of these layer pairs can be used.

FIG. 3B shows another example of a neural network 350 that can be used as machine learning model 111. This example omits illustration of the input layer at the beginning and the output layer at the end, but the model 350 would typically include these layers. The model 350 includes five layer pairs each including a convolution followed by a batch normalization. For example, there is a convolution layer 351 followed by batch normalization layer 352, convolution layer 353 followed by batch normalization layer 354, convolutional layer 355 followed by batch normalization layer 356, convolutional layer 357 followed by batch normalization layer 358, and convolutional layer 359 followed by batch normalization layer 360. The model 350 then includes three deep neural network layers 361-363.

The model 350 varies some of the layer dimensions and numbers of parameters used at different layers, as well as changing other parameters used for training. For example, The kernel size used for the convolutional layers varies: 3×3×3×32, then 3×3×32×64, then 3×3×64×96, then 3×3×96×96, then 3×3×96×64. The convolutions performed are two-dimensional convolutions, over the width and height of the two-dimensional snapshot image provided as input. There are typically three color channels, red, green, and blue, for each image. In the colonel specification, the last two numbers indicate the height and width and number of pixels or pixel values that are covered by the kernel. For example, 3×32 represents the 3 pixel by 32 pixel area of the image being covered by the convolutional filter kernel for that layer. The first two numbers indicate that there are three different filters, and that each is applied across the three different color channels. Across the first three compositional layers, the horizontal and vertical dimensions of the kernel progressively increase, so that an increasingly larger area is encompassed by the kernel, e.g., 3×32, 32×64, 64×96, 96×96. Initially, the area of the kernel is a narrow strip, with a vertical dimension several times larger than the horizontal dimension. The aspect ratio changes until it is square at the convolutional layer 357. After that, the final convolutional layer is again rectangular and not square, this time with a wider horizontal dimension then vertical dimension in the convolution layer 359.

The batch normalization layers also have different parameter values. The moving mean and moving variance are typically pre-specified parameters. These values increase progressively over the first three batch normalization layers, from 32, to 64, then to 96. After the fourth batch normalization layer 358, the mean and variance decrease to 64. The normalization parameters of gamma and beta have a similar pattern. Nevertheless, in some implementations, gamma and beta can be learnable parameters that may be adjusted through training. In general, the changing of the parameters from layer to layer, including the convolutional kernel sizes, indicates that the neural network is encompassing increasingly large amounts of data about the input image within the convolutional filter. For example, the convolution at layer 357 incorporates a much larger set of values, and includes information derived from a much larger portion of the input image, than are used in the initial convolution at layer 351.

The three deep neural network layers 361 to 363 have decreasing numbers of parameters or nodes. For example, the layer size changes from 3136×256, to 256×128, to 128×2. The bias for these levels also decreases from one DNN layer later to the next.

FIG. 4 illustrates an example of a system 400 the trains and uses machine learning models to classify the state of display devices. As described in FIGS. 1 and 2, the computer system 110 includes a model training module 230 and training data 210 that can use to train a machine learning model 111. In the system 400, the computer system 110 is configured to provide management services for display devices of different networks or customers, each of which can have multiple display devices to be managed. The computer system 110 receives data from and provides data to various devices through an API gateway 402.

In the example, there are two different networks supported by the computer system 110. These networks represent the infrastructure or devices of different companies, departments or other groups, and are not required to be separate computer networks. Network 1 includes media signage server 410a, which can be implemented in cloud computing resources, in the data center, and an on premises server, or in another manner. Network 1 also includes two display devices 130a and 130b that communicate with the server 410a. Network 1 can represent a network used by a particular company, with the display devices 130a and 130b potentially being in the same building or different buildings. Network 2 has its own media signage server 410b, which manages display devices 130c and 130d. Network 2 can represent a different company or system than Network 1.

The content displayed on display devices in Network 1 (e.g., layout, formatting, style, templates used, media items shown, etc.) can be very different from what is displayed by devices in Network 2. As a result, the visual properties that are present during normal operation (or for any other state classification) can vary from one network or customer to another. For example, a section of the screen might normally be all black for one company's user interface, but for another company, that same section of screen may be entirely black only when there is a malfunction or content missing from the user interface.

To provide high accuracy, the computer system 110 can train and use specialized machine learning models for the different networks, e.g., network-specific models. For example, in addition to the general model 111, the computer system 110 trains and stores a model 111a for Network 1, and a model 111b for Network 2. The models 111a and 111 b can be generated by performing further training on the general model 111 that is specifically focused for each network's particular patterns and content. For example, the Network 1 model 111a can be generated by further training the general model 111 with a set of training examples specifically from display devices of Network 1. Similarly, the network to model 111b can be generated by training the general model further using training data examples based on actual images presented by display devices and network too. This way, the resulting models 111a and 111 b benefit from the general classification ability trained into the general model 111, while the training is fine tuned for the specific circumstances and visual patterns that occur in each network specifically.

To facilitate this training, the display devices 130a-130d each provide screenshot images and telemetry data to their corresponding media signage servers 410a, 410b, which pass the data onto the computer system 110 over the network 120. In some implementations, the telemetry can indicate information about the state of the display device, such as amount of uptime, software applications running and the versions of those applications, sensor data indicating characteristics of an environment of the display device, or other context information. In addition, The telemetry can include state data for the device, such as log entries, error codes or error messages that were issued, and so on. In some cases, the telemetry maybe used by the computer system 110 to determine a state of the display device or a classification representing the ground truth state of the display device, which may then be used as a label for training.

When screenshots and corresponding telemetry are provided, the data can be annotated with information about the display device that originated the data. For example, the physical location of the device, type of device, configured mode of operation of the device, and other information can be provided. In addition, identifiers for the network or media signage server corresponding to the data can be included in metadata or other tags. With this information, the computer system 110 can group data related to the same network, and train each network-specific model using the examples that were generated by that network.

In the system 400, the display device is 130a-130d each periodically send screenshot images to their corresponding media signage server 410a, 410b. For example, the screenshot images may be provided every minute, every five minutes, or add another interval. The media signage servers 410a, 410b send each screenshot image to the computer system 110 in a request for a classification. The request for classifications are provided through the API gateway 402. The computer system 110 Than performs inference processing for each of the requests received. For example, screenshot images received from the server 410 are each separately processed using the model 111a for Network 1. Screenshot images received in requests from server 410b are each separately processed using the model 111b for Network 2. In response to each classification request, the computer system 110 provides a classification result through the API gateway 402. For example, the classification result can be an indication of the classification that the machine learning model indicated to be most likely given the screenshot image.

The media signage servers 410a, 410b then use the classification results to determine whether any changes are needed for the display devices 130a-130d. For example, if the classification for the display device 130a is “normal operation, “then no change or correction is needed. On the other hand, if the server 410a determines that the classification four the display device 130b indicates “partially corrupted content,” then the server 410a can select and instruct an appropriate corrective action. Each of the media signage servers 410a, 410b can store data structures or algorithms that indicate corrective actions to perform or settings to change in response to detecting different classifications. For example, the servers 410a, 410b can store rules, tables, models, or other data that enable the server 410a, 410b to map a classification to a corrective action. As a few examples, if display content is partially or completely missing or corrupted, corrective actions may include closing and re-opening an application, initiating a content refresh cycle, performing a soft reboot of the display device, performing a hard reboot of the display device, restoring one or more display device settings or software settings to a default or reference state, initiating a change in mode of operation of a display device, clearing or refilling a content cache, and so on. Combinations of these actions can be selected and performed as appropriate. In addition, the servers 410a, 410b can be configured to perform sequences of corrective actions. For example, after instructing the display device 130b to perform a soft restart, the server 410a can monitor the subsequent classification determined for the device, after the next screenshot image is provided and processed. If the classification has not returned to the normal or desired state, the server 410a may proceed with a further or different corrective action. In this matter, the servers 410a, 410b can track instances of undesired states or undesired classifications, and can take repeated steps across multiple monitoring cycles, using later classifications as feedback to verify whether a previous corrective action was successful.

In many cases, the corrections instructed or initiated by the servers 410a, 410b are effective to return the display devices 130a-130d to a desired operating state. Nevertheless, in some cases and for some classifications, interactions with other systems or with administrators maybe you needed. As a result, the servers 410a, 410b can, as part of selecting remediation actions, send messages, notifications, alerts, or other communications to administrators. For example, in response to receiving the classification from the computer system 110, the server 410a can alert an administrator that the device 130b is classified to be in an abnormal state or error state. Communications with administrators or other human users can be made through email, SMS text message, through notifications in an application, or through other means.

The computer system 110 also supports an administrator 141 by providing status data for a user interface on the administrator's device 140. For example, the API gateway 402 can provide information about the operating state of display devices on one or more networks. For example, the API gateway 402 can provide status values, recent classification results, historical classification statistics, alerts, and more. The information may be presented in a native application running on the administrator's device 140, with metrics and performance indicators provided by the API gateway 402. In other implementations, the computer system 110 may provide the information as part of a webpage or web application, and so may provide user interface data to be rendered and displayed by the administrator's device 140. In other implementations the status data and user interface data may be provided not by the computer system 110 or the API gateway 402, but by the media signage servers 410a, 410b. For example, the server is 410a, 410b may respectively store current and historical information about the display devices they respectively manage, and so may provide this through a network accessible interface.

FIG. 5 shows another example of a system 500 for managing display devices. Like the system 400 in FIG. 4, the system 500 includes the computer system 110, the API gateway 402, the servers 410a, 410b, The display devices 130a-130d, and the administrator's device 140. The system 500 is able to operate in the manner described with respect to FIG. 4, with servers 410a, 410b sending requests through the API gateway 402 and the computer system 110 sending classification results in response to the requests. However, the network-specific models 111a, 111 b are stored at the media signage servers 410a, 410b so that the servers 410a, 410b can generate classifications locally without using the API gateway 402. Thus, the media signage servers 410a, 410b can each perform classification inference processing without the need for additional network traffic to the computer system 110.

The system 500 also facilitates federated learning and distributed model training. Each of the servers 410a, 410b includes a model training module 411a, 411 b. As the servers receive additional classification data they can repeatedly update the local network-specific model that they are using based on the examples of conditions observed in their respective networks.

The servers 410a, 410b can provide the screenshots did they receive from display devices 130a-130d to the computer system 110 through the API gateway 402. Even if classification results from the computer system 110 are not needed, it is beneficial for the computer system 110 to continue collecting the screenshots for use as additional training data 210. With this training data 210, the computer system 110 can further update the general model 111, and can also perform further training for its own version of network-specific models 111a-111b. In addition to receiving the screenshots from display devices, the computer system 110 can receive model updates that represent changes to the local copies of the network-specific models 111a, 111 b. The computer system 110 can incorporate these changes into its version of the network-specific models 111a, 111b. Periodically, for example once a month, the computer system 110 can generate an updated general model 111, and also create an updated network specific model 111a-111b for each network. The updated network-specific models 111a, 111b can be based on the on the updated network-specific models 111a, 111b can be based on the most recent and most accurate general model 111, while still being customized or tailored for their respective networks using the collective training data 210 that the computer system 110 has received for the respective networks, and/or incorporating the updates from the local model training done by the servers 410a, 410b. The computer system 110 can then send the updated network-specific models to the appropriate servers 410a, 410b, where they can replace the locally stored network-specific models 111a, 111 b.

Even though the servers 410a, 410b have the capability to perform classification locally, the computer system 110 can retain the ability to receive and respond to requests for classification made through the API gateway 402. This can provide redundancy in the case that a media signage server 410a, 410b becomes unavailable. In addition, it allows load balancing, so that servers 410a, 410b can delegate classification processing to the computer system 110 when load at the media signage server itself is high. Finally, it permits hybrid architectures in which some media signage servers may be configured to perform classification locally, while other media signage servers may be configured to instead rely on the classification processing done by the computer system 110. This allows significant versatility in the range of processing capability and computing resources that may be used for the media signage server function.

FIG. 6 shows another example of a system 600 for managing display devices. The system 600 includes the same elements described for the system 500 in FIG. 5, and can operate in the same manner as described for the system 500 (FIG. 5) or the system 400 (FIG. 4). In addition, the system 600 enables a further level of distributed model usage and training, with display devices each having a corresponding copy of the appropriate machine learning model. This enables display devices 130a-130d to each perform classification processing on their own screenshot images locally, without requiring network access or relying on a media signage server 410a, 410b or API gateway 402. The ability to run classifications locally at each display device 130a-130d reduces network traffic and makes more frequent classification cycles feasible, e.g., every 10 seconds or so, or even more frequently, if desired.

The use intelligent edge processing means that the trained machine learning model, in addition to being hosted and served from the cloud (or a customer data center), is also available locally. Thus, a display device or an associated intelligent edge device can monitor the display device in real time, get inference results for the screenshot in real time or substantially in real time, and also initiate corrective action if required. To contrast this from the cloud (or data center) hosted model scenario, where the media signage server has to pull a screenshot (or the media signage device has to push the screenshot to the media signage server) which could be at some near-real time periodicity of several minutes (say 5 minutes) or even an hour, in the edge-hosted model the intelligent edge could monitor the screen content of a display device every minute or even more frequently. The edge device can also take corrective action can work in the absence of network connectivity. The intelligent edge can also participate in federated learning to train a model in real time along with other participating media signage devices in the same network.

The system 600 also enables federated learning through distributed training that occurs at each of the display devices 130a-130d. The display devices 130a-130d can update the training of their local models and provide the updates to the corresponding server 410a, 410b, which can aggregate those updates into their respective models 111a, 111 b and re-distribute the updated models 111a, 111 b across the display devices on their respective networks. Those model updates from the devices 130a-130d and/or the servers 410a-410b can also be sent to the computer system 110, which can further aggregate the distributed training results into the general model 111 or other models.

In FIG. 6, each of the display device is 130a-130d is shown having a corresponding edge device 601a-601d. The edge devices 601a-601d can be processors or processing units within (e.g., part of or integrated with) the corresponding display devices 130a-130d, or the edge devices 601a-601d can be separate devices (e.g., small form-factor computers, set-top boxes, etc.) in communication with the display devices 130a-130d. Each edge device 601a-601d stores its own local model 602a-602d. For network 1, the edge devices 601a, 601 b each initially receive the main network 1 model 111a, and then further train that model 111a to generate the updated local models 602a, 602b based on the screenshots and data collected from the corresponding display device 130a, 130b. The edge devices 601d, 601d also respectively store models 602c, 602d that are originally based on the network 2 model 111b. Periodically, such as each week or each month, the updated models, or an indication of changes to the models that have occurred through training, can be provided to the server 410a, 410b, which can aggregate the distributed updates into updated versions of the models 111a, 111 b, which are then provided to the display devices 130a-130d and edge devices 601a-601d for use in inference processing and further local updates.

In some implementations, the rules, tables, or other data structures for selecting remediation actions are stored locally at the display devices 130a-130d or edge devices 601a-601d. As a result, when each edge device 601a-601d determines a classification using its local model 602a-602d, the edge device 601a-601d can also select and perform remediation actions if appropriate for the determined classification (e.g., refreshing a cache or store of content, rebooting the display device, changing a setting, sending an alert, etc.). In this scenario, the monitoring of display devices and the automatic correction of many undesirable states of display devices can be performed locally without the need for network access. In other implementations, or as a backup option, the display devices 130a-130d may still send classifications determined and/or screenshots and other telemetry data to the corresponding server 410a, 410b, which can select and instruct remediation actions.

For any of the configurations discussed herein, the media signage server or the intelligent edge device that receives the inference result, e.g., a classification from the machine learning model (e.g., whether the classification is determined locally or received through an API), then performs remediation action if the display is not in a normal state. Examples of remediation include items such as performing a soft-reset of the display device. This could be similar to resetting some power circuitry for just the screen but not the entire media signage device, could be restarting some internal processes that render the apps on the screen. As another example, the remediation action may include performing a hard-reset (power cycling) of the display device so that all the electronic circuitry is reset. As another example, the system may switch storage to internal storage if the USB storage has failed. In many cases, software applications and/or displayable content may be stored on a USB removable storage device and/or internal storage of the display device. As another example, a remediation action can include creating a ticket in an issue tracking system so that a customer support agent can manually evaluate the device and take corrective actions.

Metrics are logged in a database in the cloud, e.g., by the computer system 110, for every remediation action and made available on an internal portal and also a customer facing portal. Downstream applications can then track and trend these metrics to determine both why certain problems are happening and which remediation actions fix those problems. These metrics can then be compared and contrasted across networks, across media signage device models, media signage server models, etc.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on one or more non-transitory computer-readable media for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method performed by one or more computers, comprising:
receiving, by the one or more computers, image data over a communication network, the image data representing an image provided for presentation by a display device;
processing, by the one or more computers, the image data using a machine learning model that has been trained to evaluate status of display devices based on input of image data corresponding to the display devices, wherein the machine learning model has been trained based on training data examples that include image data from multiple display devices and include examples for different classifications in a predetermined set of classifications;
selecting, by the one or more computers, a classification for a status of the display device based on the output that the machine learning model generated based on the image data, wherein the classification is selected from among the predetermined set of classifications; and
providing, by the one or more computers, an output indicating the selected classification over the communication network in response to receiving the image data.

2. The method of claim 1, wherein the machine learning model is a convolutional neural network.

3. The method of claim 1, further comprising training the machine learning model based on training data examples from multiple display devices, each of the training examples comprising a screen capture image and a label indicating a classification for the screen capture image.

4. The method of claim 1, comprising providing an application programming interface (API) that enables remote devices to request classification of image data using the API;
wherein receiving the image data comprises receiving the image data using the API; and
wherein providing the output indicating the selected classification comprises providing the output using the API.

5. The method of claim 1, wherein providing the output comprises providing the output to the display device, to a server associated with the display device, or to a client device of an administrator for the display device.

6. The method of claim 1, comprising:
determining, based on the selected classification, that the output of the display device is not correct or that the display device is not in a desired operating state;
based on determining that the output of the display device is not correct or that the display device is not in a desired operating state, selecting a corrective action to improve output of the display device; and
sending, to the display device, an instruction for the display device to perform the selected corrective action.

7. The method of claim 6, wherein the corrective action comprises at least one of changing content to display, changing a display setting, changing a network setting, changing an operating mode, restarting the display device, closing or re-opening an application, initiating a content refresh cycle, restoring one or more settings to a default or reference state, or clearing or refilling a cache of content.

8. The method of claim 6, wherein selecting the corrective action comprises using stored rules that specify different corrective actions to perform for different classifications in the predetermined set of classifications.

9. The method of claim 6, comprising tracking a status of the display device over time to verify whether normal operation of the display device occurs after instructing the corrective action to be performed.

10. The method of claim 1, further comprising:
for each of multiple display devices:
receiving a series of different screen capture images obtained at different times;
determining a classification for each of the screen capture images using the machine learning model; and
tracking status of the display device by storing records indicating the classifications determined for the screen capture images.

11. The method of claim 1, wherein the machine learning model is configured to provide, in response to receiving input image data, a set of scores comprising a score for each of the classifications in the predetermined set of classifications.

12. The method of claim 1, wherein the received image data is a down-sampled version of a screen capture image generated by the display device.

13. A system comprising:
one or more computers; and
one or more computer-readable media storing instructions that are operable, when executed by the one or more computers, to cause the system to perform operations comprising:
receiving, by the one or more computers, image data over a communication network, the image data representing an image provided for presentation by a display device;
processing, by the one or more computers, the image data using a machine learning model that has been trained to evaluate status of display devices based on input of image data corresponding to the display devices, wherein the machine learning model has been trained based on training data examples that include image data from multiple display devices and include examples for different classifications in a predetermined set of classifications;
selecting, by the one or more computers, a classification for a status of the display device based on the output that the machine learning model generated based on the image data, wherein the classification is selected from among the predetermined set of classifications; and
providing, by the one or more computers, an output indicating the selected classification over the communication network in response to receiving the image data.

14. The system of claim 13, wherein the machine learning model is a convolutional neural network.

15. The system of claim 13, wherein the operations further comprise training the machine learning model based on training data examples from multiple display devices, each of the training examples comprising a screen capture image and a label indicating a classification for the screen capture image.

16. The system of claim 13, wherein the operations further comprise providing an application programming interface (API) that enables remote devices to request classification of image data using the API;
wherein receiving the image data comprises receiving the image data using the API; and
wherein providing the output indicating the selected classification comprises providing the output using the API.

17. The method of claim 1, wherein providing the output comprises providing the output to the display device, to a server associated with the display device, or to a client device of an administrator for the display device.

18. The system of claim 13, wherein the operations further comprise:
determining, based on the selected classification, that the output of the display device is not correct or that the display device is not in a desired operating state;
based on determining that the output of the display device is not correct or that the display device is not in a desired operating state, selecting a corrective action to improve output of the display device; and
sending, to the display device, an instruction for the display device to perform the selected corrective action.

19. The system of claim 18, wherein the corrective action comprises at least one of changing content to display, changing a display setting, changing a network setting, changing an operating mode, restarting the display device, closing or re-opening an application, initiating a content refresh cycle, restoring one or more settings to a default or reference state, or clearing or refilling a cache of content.

20. One or more computer-readable media storing instructions that are operable, when executed by one or more computers, to cause the one or more computers to perform operations comprising:
receiving, by the one or more computers, image data over a communication network, the image data representing an image provided for presentation by a display device;
processing, by the one or more computers, the image data using a machine learning model that has been trained to evaluate status of display devices based on input of image data corresponding to the display devices, wherein the machine learning model has been trained based on training data examples that include image data from multiple display devices and include examples for different classifications in a predetermined set of classifications;
selecting, by the one or more computers, a classification for a status of the display device based on the output that the machine learning model generated based on the image data, wherein the classification is selected from among the predetermined set of classifications; and
providing, by the one or more computers, an output indicating the selected classification over the communication network in response to receiving the image data.
